(19) United States
(12) Patent Application Publication
(10) Pub. No.: US 2014/0068192 A1
(43) Pub. Date: Mar. 6, 2014

(54) PROCESSOR AND CONTROL METHOD OF PROCESSOR

(71) Applicant: FUJITSU LIMITED, Kawasaki-shi (JP)

(72) Inventors: AKHILA ISHANKA RATNAYAKE, Kawasaki (JP); Toru Hikichi, Inagi (JP)

(21) Appl. No.: 13/912,155

(22) Filed: Jun. 6, 2013

(30) Foreign Application Priority Data
Aug. 30, 2012 (JP) 2012-190441

(51) Int. Cl. G06F 12/08

(52) U.S. Cl. CPC G06F 12/0811
USPC 711/122

(57) ABSTRACT

A processor includes a plurality of CPU cores, each having an LI cache memory, that executes processing and issues a request, and an L2 cache memory connected to the plurality of CPU cores, the L2 cache memory is configured, when a request which requests a target data held by none of the L1 cache memories contained in the plurality of CPU cores, is a load request that permits other CPU cores, to make a response to the CPU core having sent the request, with non-exclusive information that indicates that the target data is non-exclusive data, together with the target data; and when the request is a load request that forbids other CPU cores, to make a response to the CPU core having sent the request, with exclusive information that indicates that the target data is exclusive, together with the target data.

### CROSS-REFERENCE TO RELATED APPLICATION

This application is based upon and claims the benefit of priority of the prior Japanese Patent Application No. 2012-190441, filed on Aug. 30, 2012, the entire contents of which are incorporated herein by reference.

### FIELD

The embodiment discussed herein relates to a processor, and a control method of a processor.

### BACKGROUND

There has been known a cache system capable of transferring an exclusive right in a clean state, such as enabled by adopting the MESI (Modified, Exclusive, Shared, Invalid) protocol. The individual states of the MESI protocol are as follow. M (Modified) state represents a state where none of the other requestors, but only a cache memory holds data with an exclusive right. The data is different from data stored in a low-order cache memory (or a memory). The data may be modified by an arbitrary storing operation from this state, while keeping the cache memory in the M state. When the cache memory is transferred to I state, it needs be updated by the data having been held by the low-order cache memory (or memory) (write-back).

E (Exclusive) state represents a state where none of the other requestors, but only the cache memory holds data with an exclusive right. The data is different from data held by the low-order cache memory (or memory). The data may be modified by an arbitrary storing operation, and the cache memory changes into the M state upon modification of the data. S (Shared) state represents a state where the cache memory holds data without an exclusive right. The data is same as data in the low-order cache memory (or memory). If there is a plurality of requestors, the plurality of requestor may be brought into the S state (shared state) at the same time. For storing, the cache memory needs to acquire the exclusive right to change into the E state. I (Invalid) state represents that the cache memory holds no data.

In this sort of cache system, when a certain data block is held by an L2 (Level-2) cache memory in the E state or the M state, but not by the other requestors, upon issuance of a load request from a certain register, there are two ways of making a response to the requestor: “response in the E state” and “response in the S state”. The paragraphs below will explain an exemplary system having a plurality of CPU cores as processing sections, each of which having a calculation section and an L1 (Level-1) cache memory, and the individual cores share an L2 (Level-2) cache memory. The individual CPU cores correspond to the requestors, and the L2 cache memory makes a response to a destination. In the description below, the low-order cache memory is defined to be kept in the E state.

FIG. 16A illustrates an exemplary case where at first the L1 cache memory of core 0 (Core-0), which is a high-order cache memory, issues a load request (LD request), and the L2 cache memory, which is a low-order cache memory, makes a response in the E state. Next, when the L1 cache memory of the core 1 (Core-1), which is another requestor, issues a load request on the same cache line, a snoop transaction takes place in the S state between it and the core 0 of the first requestor, and the data is shared. This example is disadvantageous in terms of performance, since the snoop transaction occurs.

FIG. 17A illustrates an exemplary case where at first the L1 cache memory of the core 0, which is a high-order cache memory, issues a load request, and the L2 cache memory, which is a low-order cache memory, makes a response in the S state. In this case, even if next another requestor issues the load request on the same cache line, the snoop transaction does not take place between the first requestor and another requestor, unlike the exemplary case illustrated in FIG. 16A, so that the data may immediately be shared, proving it superior to the example illustrated in FIG. 16A in terms of performance.

As illustrated in flow charts of FIGS. 18A and 18B, in the example illustrated in FIG. 16A, the data is fed at time T101 in FIG. 18A to a functional unit, whereas in the example illustrated in FIG. 17A, the data is fed at time T102 illustrated in FIG. 18B, which is earlier than time T101, to the functional unit. In FIG. 18A and FIG. 18B, Core-0 L1-pipe represents a pipeline processing by the L1 cache memory of the core 0, and Core-1 L1-pipe represents a pipeline processing by the L1 cache memory of the core 1. L1-pipe represents a pipeline processing by the L2 cache memory.

On the other hand, as illustrated in FIG. 16B, for the case where the L1 cache memory of the core 0 issues the load request first, and the L2 cache memory then makes a response to it in the E state, upon issuance of a store request (ST request) by the core 0 on the same cache line for the next time, the core 0 can immediately execute the store processing since it holds the data in the E state. In contrast, as illustrated in FIG. 17B, for the case where the L1 cache memory of the core 0 issues the load request first, and the L2 cache memory then makes a response to it in the S state, upon issuance of the store request by the core 0 on the same cache line for the next time, the core 0 now needs to issue a store request, since it holds the data in the S state.

As described above, both cases are in a trade-off in terms of performance. The cache system is generally designed so that, when a certain core issues the load request in the state of “data held by no core”, the core “makes a response in the E state” assuming that only the core uses the data.

There has been proposed a method of controlling a cache memory, for which a change flag is set when the data is written into a processor, and is asked to reset the change flag when the data is read out from the processor, wherein the change flag is reset by a specific command (for example, refer to Patent Document 1).
[Patent Document 1] Japanese Laid-open Patent Publication No. 04-48358

Problems will, however, arise in the cache system designed to make a response in the E state, when a load request is issued by a certain core, while none of the cores holds data, in the following cases. That is a case where a certain address is repetitively referred multiple times by a plurality of cores, the cache memory is replaced, and thereby all cores are brought into a state of having no data. If any one core holds the data, it is of no problem since the response will be made in the S state. Very frequent replacement of the cache in the core may result in the case below. The case will be explained referring to FIG. 19A, FIG. 19B and FIG. 20.

In an exemplary case illustrated in FIG. 19A, upon issuance of a load request by the core 0, a response is made in the E state, next upon issuance of a load request by another core on the same cache line, a snoop transaction takes place between the first core and the next core, and data is shared. Upon further issuance of a load request by still another core 2 on the same cache line, a response is made in the S state to the core 2, since the data has already been shared between the core 0 and the core 1. So long as this sort of case, in which the snoop transaction occurs only for the first time and will no longer occur, is assumed, there will be no serious problem and the performance will not so degrade.

On the other hand, in an exemplary case illustrated in FIG. 19B, upon issuance of a load request by the first core 0, a response is made in the E state, the data is used for calculation, replacement takes place when a new request with the same index is issued, and the core goes into a state of having no data (goes into the I state). In this way, if the load request is issued by the core 2 while the data is held by no core, a response is made in the E state since no core holds the data. Also in this case, the performance will not degrade since no snoop transaction will occur.

In contrast, in an exemplary case illustrated in FIG. 20, upon issuance of a load request by the first core 0, a response is made in the E state, next upon issuance of a load request by another core 1 on the same cache line, a snoop transaction occurs between the first core and the next core, and the data is shared. If the cache is invalidated by replacement after a sufficiently long time has elapsed after making reference to the data block, before the core 2 issues a load request on the same cache line, a response to the core 2 is made in the E state. Accordingly, if a load request is issued in this state by another core or core 1 on the same cache line, the snoop transaction occurs again, and thereby the performance will degrade as compared with the cases illustrated in FIG. 19A and FIG. 19B. Conditions of occurrence of such different operation described above depend on timing. Such degradation in performance, due to slight differences in timing and operational conditions of CPU, is generally considered as less favorable.

### SUMMARY

According to one aspect, a processor includes a plurality of processing sections, each including a first cache memory, that executes processing and issues a request; and a second cache memory. The second cache memory is configured, when a request which requests a target data held by none of the first cache memories contained in the plurality of processing sections, and is received from any one of the plurality of processing sections, is a load request that permits a processing section other than the processing section having sent the request to hold the target data, to make a response to the processing section having sent the request, with non-exclusive information which indicates that the target data is non-exclusive data, together with the target data. The second cache memory is also configured, when the request is a load request which forbids a processing section other than the processing section having sent the request to hold the target data, to make a response to the processing section having sent the request, with exclusive information which indicates that the target data is exclusive, together with the target data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing illustrating an exemplary configuration of a processor in an embodiment;

FIG. 2 is a drawing illustrating an exemplary configuration of data held in a tagged memory in this embodiment;

FIG. 3 is a drawing illustrating an exemplary configuration of a hit decision section in this embodiment;

FIG. 4 is a drawing illustrating an exemplary response control in this embodiment;

FIG. 5 is a drawing illustrating an exemplary response control in this embodiment.

FIG. 6 is a drawing illustrating an exemplary configuration of a response decision section of this embodiment;

FIGS. 7A to 7C are drawings illustrating an exemplary operation of a response decision section in this embodiment;

FIG. 8 is a drawing illustrating an exemplary processing applied with this embodiment;

FIG. 9 is a drawing illustrating an exemplary implementation of load request LD(S) and load request LD(E) in this embodiment;

FIG. 10 is a drawing illustrating another exemplary implementation of load request LD(S) and load request LD(E) in this embodiment;

FIGS. 11A and 11B are drawings illustrating exemplary operations in this embodiment;

FIGS. 12A and 12B are drawings illustrating operational flows of the example illustrated in FIG. 11A;

FIGS. 13A and 13B are drawings illustrating an operational flow of an example illustrated in FIG. 20;

FIG. 14A is a drawing illustrating an operational flow of an example illustrated in FIG. 20;

FIG. 15 is a drawing illustrating another exemplary implementation of the load request LD(S) and the load request LD(E) in this embodiment;

FIGS. 16A and 16B are drawings illustrating examples where a response is made in the E state upon issuance of a load request by a first requestor;

FIGS. 17A and 17B are drawings illustrating examples where a response is made in the S state upon issuance of a load request by a first requestor;

FIGS. 18A and 18B are drawings illustrating operational flows of the examples illustrated in FIG. 16A and FIG. 17A; and

FIGS. 19A, 19B and FIG. 20 are drawings illustrating an example where a response is made in the E state upon issuance of a load request by a first requestor.

### DESCRIPTION OF EMBODIMENT

Embodiment will be described below, referring to the attached drawings.

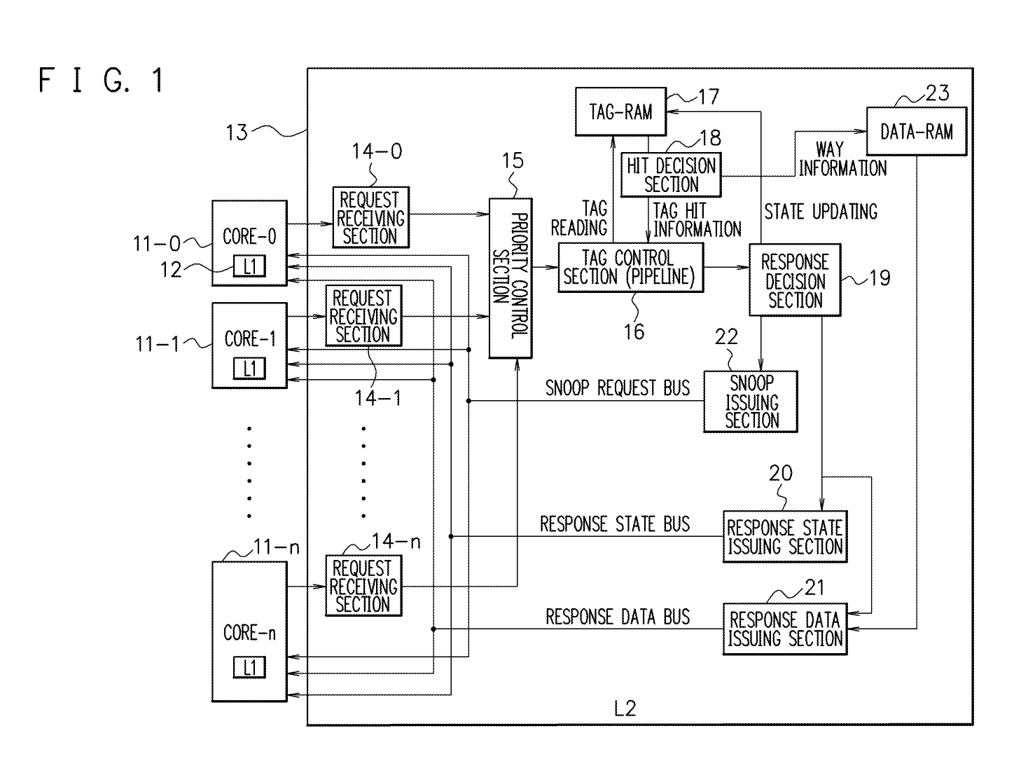

FIG. 1 is a drawing illustrating an exemplary configuration of a processor in an embodiment. The processor in this embodiment has CPU (Central Processing Unit) cores 11 (11-0 to 11-n) as a plurality of processing sections each having a calculation section and an L1 (Level-1) cache memory 12, and an L2 (Level-2) cache memory 13 shared by the individual cores 11. The L2 cache memory 13 has a plurality of request receiving sections 14, a priority control section 15, a tag control section (pipeline) 16, a tagged memory (TAG-RAM) 17, a hit decision section 18, a response decision section 19, a response state issuing section 20, a response data issuing section 21, a snoop issuing section 22, and a data memory (DATA-RAM) 23.

The request receiving sections 14 (14-0 to 14-n) are provided corresponding to the individual cores 11 (11-0 to 11-n), and receives requests from the cores 11 such as load request, store request and so forth. The requests received by the individual request receiving sections 14 are sent to the priority control section 15. The priority control section 15 selects a request to be input to the tag control section (pipeline) 16 typically according to the LRU (Least Recently Used) algorithm, and outputs it. The tag control section (pipeline) 16 directs the tagged memory 17 to read the (TAG), and receives tag hit (TAG HIT) information obtained from a process by the decision section 18. The tag control section (pipeline) 16 also outputs the requests fed from the tag hit information and the priority control section 15, to the response decision section 19.

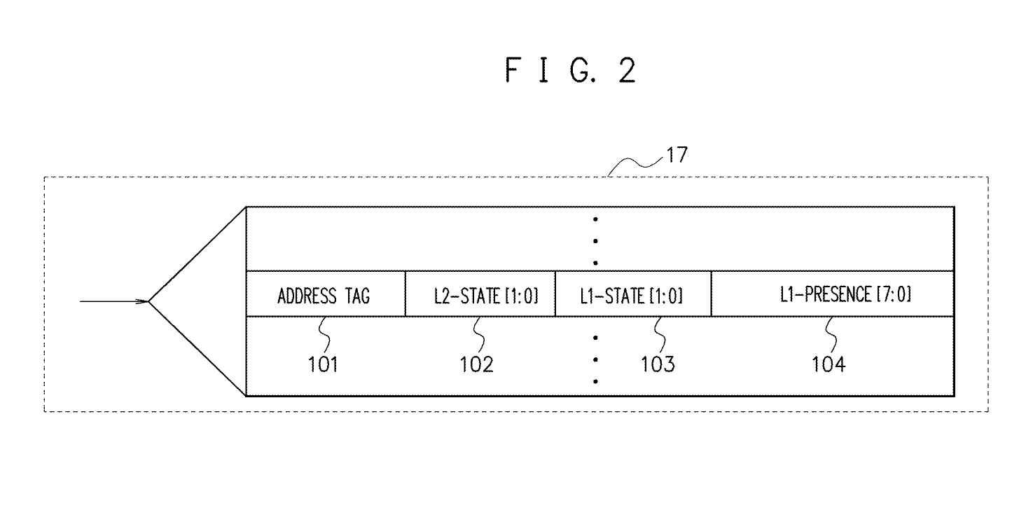

The tagged memory 17 holds data regarding data held by the data memory. The tagged data contains information regarding states of the individual cache memories and information regarding which L1 cache memory 12 of the core 11 holds data. An exemplary configuration of the data held in the tagged memory 17 is shown in FIG. 2. Each tagged data contains an address tag 101, state information (L2-STATE) 102 of the L2 cache memory, state information (L1-STATE) 103 of the L1 cache memory, and data holding information (L1-PRESENCE) 104 of the L1 cache memory.

The address tag 101 is tag information regarding an address of data held in the data memory 23. The state information (L2-STATE) 102 of the L2 cache memory is 2-bit information indicating a state of the L2 cache memory. In this embodiment, it is defined that value “0” (00b) represents the I state, value “1” (01b) represents the S state, and value “2” (10b) represents the M state, and value “3” (11b) represents the E state.

The state information (L1-STATE) 103 of the L1 cache memory is 2-bit information indicating a state of the L1 cache memory. In this embodiment, it is defined that value “0” (00b) represents that none of cores hold the data (I), value “1” (01b) represents that one core holds the data in the S state (S), value “2” (10b) represents that two or more core hold the data in the S state (SHM), and value “3” (11b) represents that one core holds the data in the E state (E). The data holding information (L1-PRESENCE) 104 of the L1 cache memory is information regarding which core holds the data. In this embodiment, the information has 8 bits corresponding to 8 cores, where the core holding the data is assigned with value “1”, and the core not holding the data is assigned with value “0”. Accordingly, which core holds the data may uniquely be expressed, based on combinations of the state information (L1-STATE) 103 of the L1 cache memory and the data holding information (L1-PRESENCE) 104.

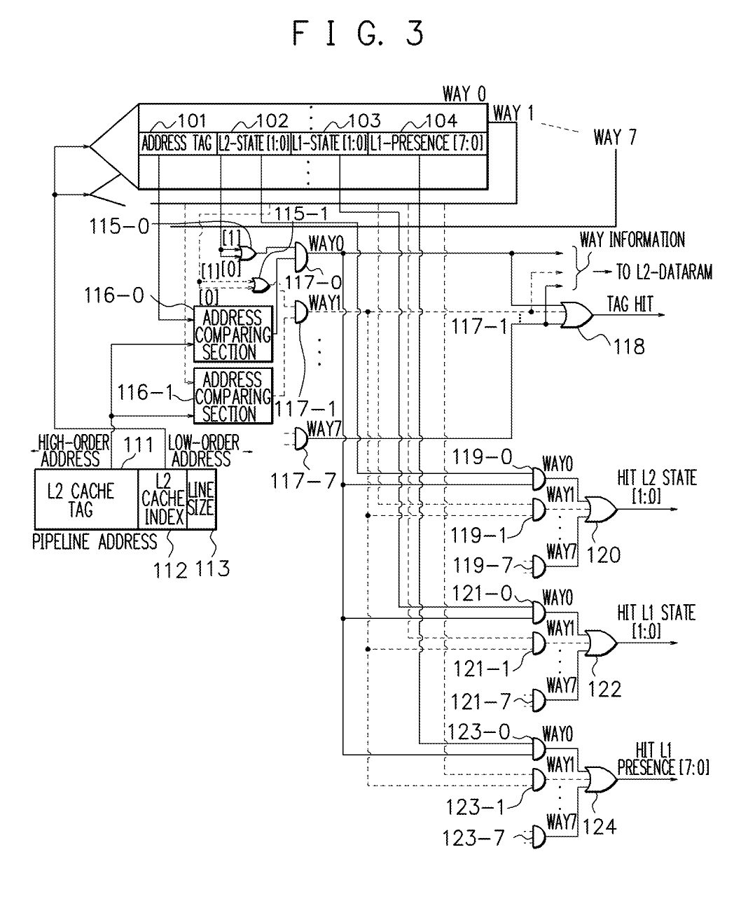

The hit decision section 18 compares a pipeline address based on the request fed by the priority control section 15, with the tagged data read out from the tagged memory 17, and determines whether the L2 cache memory contains any data corresponded to the pipeline address. FIG. 3 is a drawing illustrating an exemplary configuration of the hit decision section 18. Note that FIG. 3 illustrates an exemplary case of 8-way configuration from WAY0 to WAY7.

According to a L2 cache index 112 corresponded to the pipeline address based on the thus-fed request, an address tag 101 of each way, state information (L2-STATE) 102 of the L2 cache memory, state information (L1-STATE) 103 of the L1 cache memory, and data holding information (L1-PRESENCE) 104 are output from the tagged memory 17.

The state information (L2-STATE) 102 of the L2 cache memory for each way is calculated by an OR circuit 115, and if the state information (L2-STATE) 102 has a value other than “0” (00b), that is, if the state is other than the I state, the output will be “1”. In other words, the OR circuit 115 corresponded to the way having a valid data outputs value “1”. The address comparing section 116 compares the address tag 101 for each way with L2 cache tag 111 having the pipeline address, and if the both agree, then outputs value “1”. The output of the OR circuit 115 and the output of the address comparing section 116 are then calculated by a logical conjunction calculation circuit (AND circuit) 117, and a result of calculation is output as way information. In other words, only the AND circuit 117 corresponded to the way identified by cache hit will output value “1”.

The OR circuit 118 subjects the outputs from the individual AND circuits 117 to logical disjunction calculation, and outputs a result of calculation as a signal TAG HIT. On the other hand, the state information (L2-STATE) 102 of the L2 cache memory on the way identified by cache hit based on an AND circuit 119 and an OR circuit 120 is selected, and is output as state information (L2-STATE) of the thus-hit L2 cache memory. Similarly, the state information (L1-STATE) 103 of the L1 cache memory on the way identified by cache hit based on an AND circuit 121 and an OR circuit 122 is selected, and is output as state information (L1-STATE) of the thus-hit L1 cache memory. The data holding information (L1-PRESENCE) 104 of the L1 cache memory on the way identified by cache hit based on an AND circuit 123 and an OR circuit 124 is selected, and is output as data holding information (L1-PRESENCE) of the thus-hit L1 cache memory.

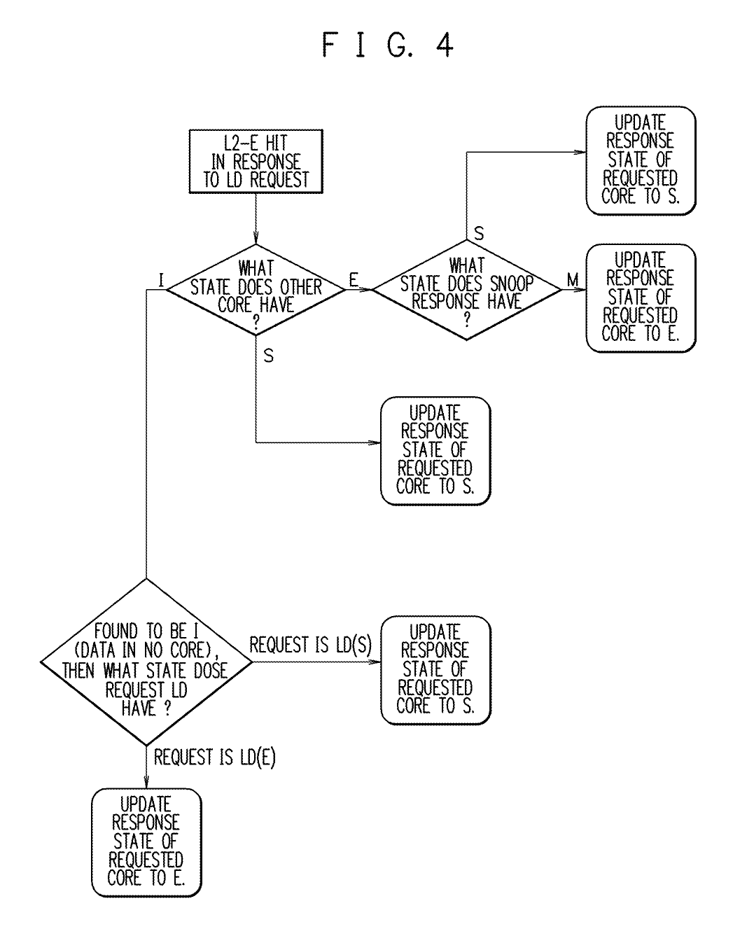

Referring now back to FIG. 1, the response decision section 19 controls issuance of the snoop request and issuance of the response state, according to the tag hit information and the request fed from the tag control section (pipeline) 16. Typically as illustrated in FIG. 4, if the L2 cache memory was hit upon issuance of the load request, the response decision section 19 confirms the state of the other cores based on the tag hit information. If the state of the other cores is the E state, the response decision section 19 updates the response state of the requested core to the S state if the snoop response state is the S state, and updates the response state of the requested core to the E state if the snoop response state is the M state. The response decision section 19 also updates response state of the requested core to the S state if the state of the other cores is E state.

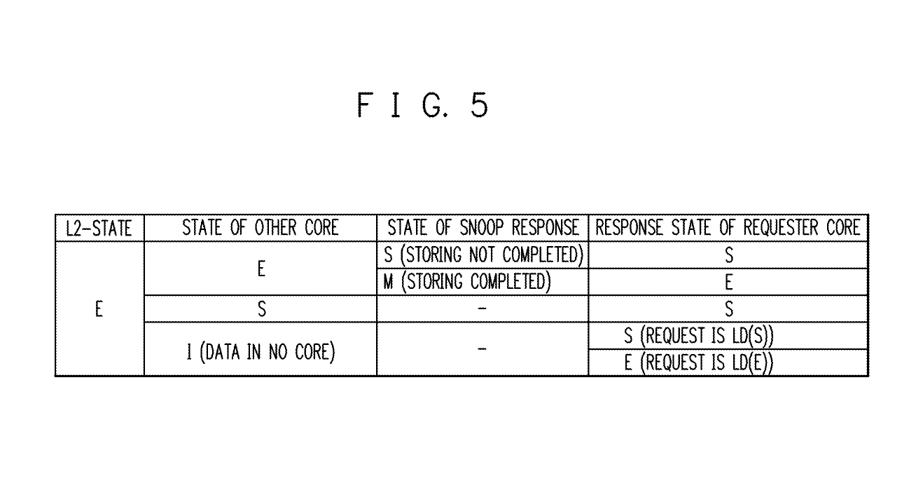

If the state of the other cores is the I state, the response decision section 19 confirms that whether the thus-issued load request is LD(S) or LD(E). The response decision section 19 updates the response state of the requested core to the S state, if the thus-issued load request is LD(S), that is, a load request which permits the other cores to hold the target data, and updates the response state of the requested core to the E state, if the load request is LD(E), that is, a load request which forbids the other cores to hold the target data. As described above, in this embodiment as illustrated in FIG. 5, if none of the cores holds data, that is, all cores are in the I state when the load request is issued by the core 11, the response state of the requested core is updated depending on the types of the load request. More specifically, in the state where none of the cores holds data, the response state of the requested core is updated to the S state if the load request LD(S) is issued, and the response state of the requested core is updated to the E state if the load request LD(E) is issued.

FIG. 6 is a drawing illustrating an exemplary configuration of the response decision section 19. The response decision section 19 has a tag state decoding section 131, a request code decoding section 132, an update tag state creating section 133, a response state creating section 134, and a snoop request creating section 135.

The tag state decoding section 131 receives the state information (L2-STATE) of the L2 cache memory corresponded to the tag hit information fed by the tag control section (pipeline) 16, state information (L1-STATE) of the L1 cache memory, and data holding information (L1-PRESENCE). The tag state decoding section 131 decodes them, and outputs the result of decoding to the update tag state creating section 133, the response state creating section 134, and the snoop request creating section 135. The request code decoding section 132 receives and decodes a request type code (REQ-CODE) contained in the request fed by the tag control section (pipeline) 16, and outputs the result of decoding to the update tag state creating section 133, the response state creating section 134, and the snoop request creating section 135.

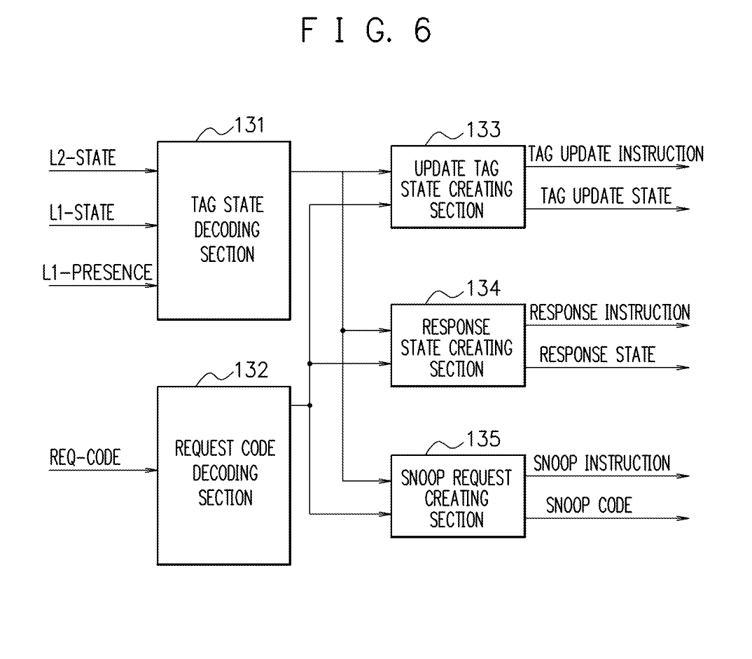

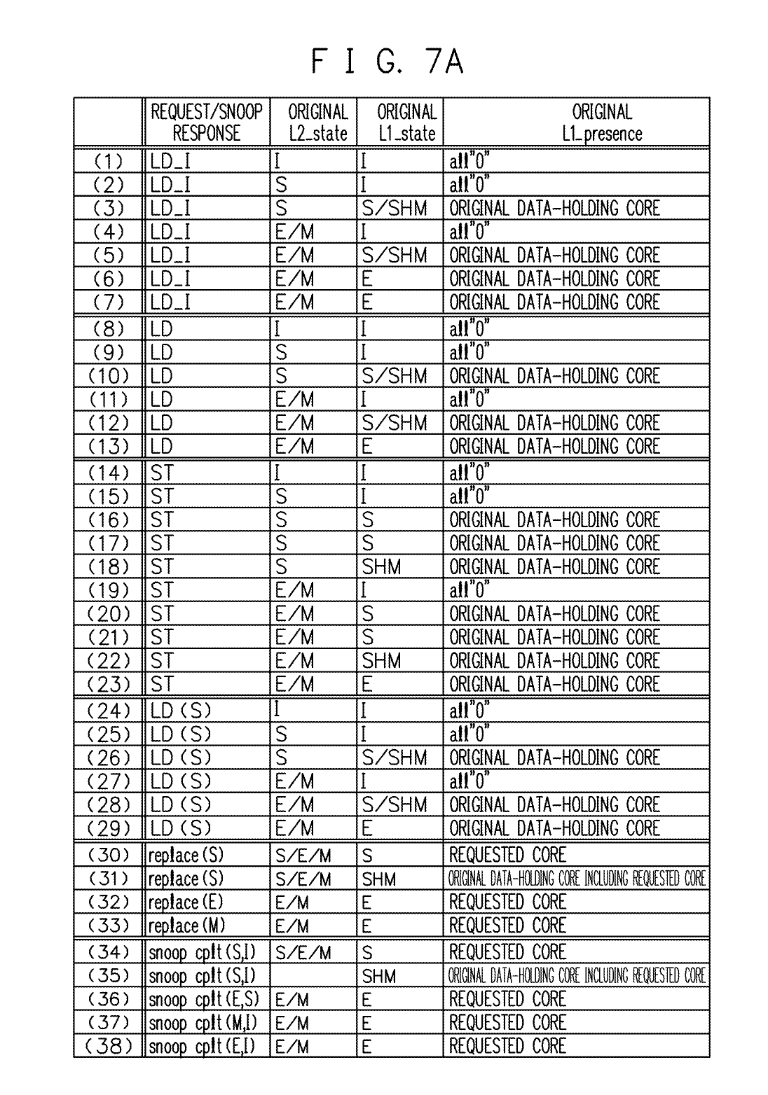

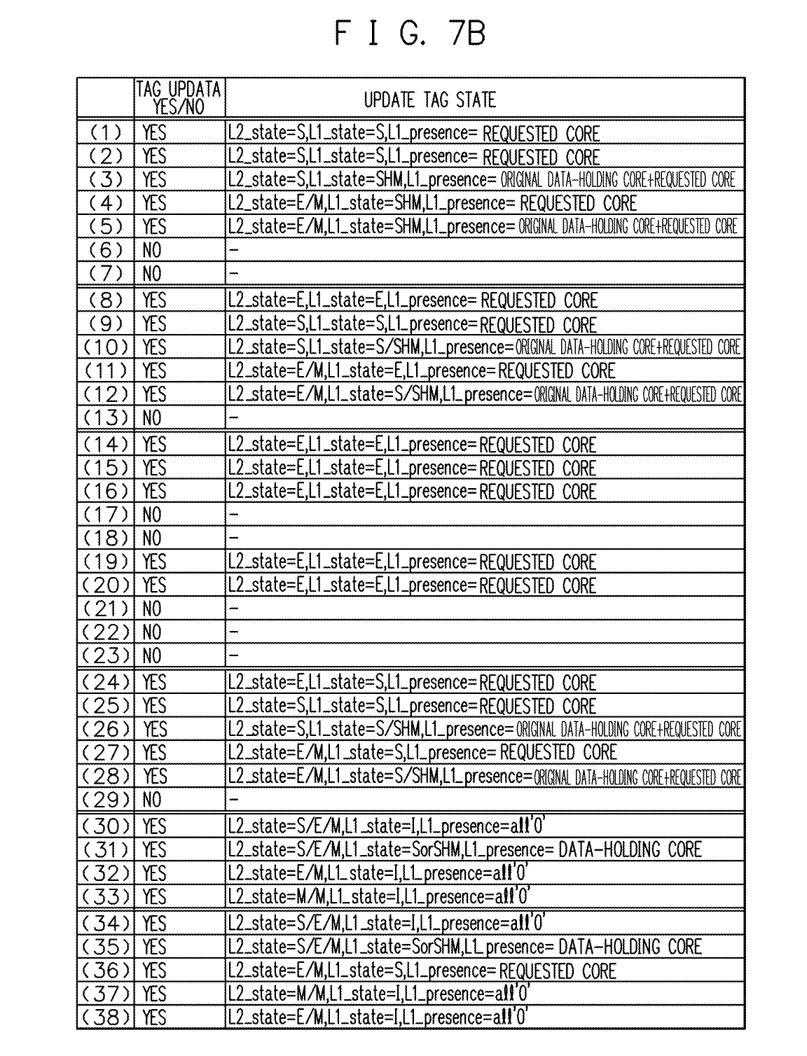

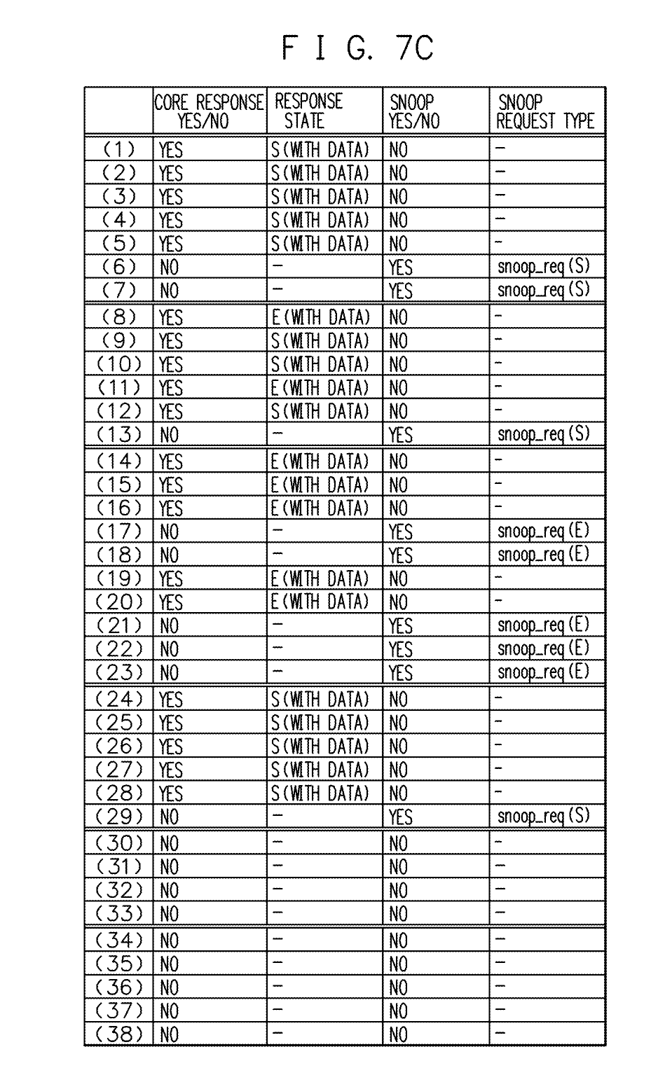

The update tag state creating section 133 determines presence or absence of the tag response, according to exemplary operations illustrated in FIG. 7A and FIG. 7B, based on the results of decoding received from the tag state decoding section 131 and the request code decoding section 132, determines a tag updating instruction and the state after the tag updating, and outputs the results as state update information to the tagged memory 17. The response state creating section 134 determines presence or absence of the core response, according to exemplary operations illustrated in FIG. 7A and FIG. 7C, based on the results of decoding received from the tag state decoding section 131 and the request code decoding section 132, determines a response instruction and the response state (including presence or absence of data), and outputs the results. The snoop request creating section 135 determines presence or absence of the snoop request directed to the cores which hold data, according to exemplary operations illustrated in FIG. 7A and FIG. 7C, based on the results of decoding fed by the tag state decoding section 131 and the request code decoding section 132, and outputs a snoop instruction and snoop request type.

The response state issuing section 20 issues the response state through a bus to the core 11, based on the response instruction and the response state received from the response decision section 19. The response data issuing section 21 also issues data output by the data memory 23 based on the way information fed by the hit decision section 18, as the response data through a response data bus to the core 11, based on the response instruction and the response state fed by the response decision section 19. The snoop issuing section 22 issues the snoop request through the bus to the core 11, based on the snoop instruction fed by the response decision section 19, and the snoop request type.

When cache misfit occurs in the L2 cache memory 13, operations involving issuance of a request to a main memory or other CPU, reception of the response, and storage of the response in the L2 cache memory 13 will occur. Constituents relevant to these operations are not illustrated.

As described above, in this embodiment, the load request LD(S) which requests a response in the S state, and the load request LD(E) which requests a response in the E state are used in the load request. The load request LD(S) and load request LD(E) are implemented as directed by software. For example, since the software knows whether the data block is to be modified (stored) or not, so that it can issue an appropriate instruction by using a load request which is less likely to be modified by a compiler or the like in the form of LD(S), and by using the other load request in the form of LD(E).

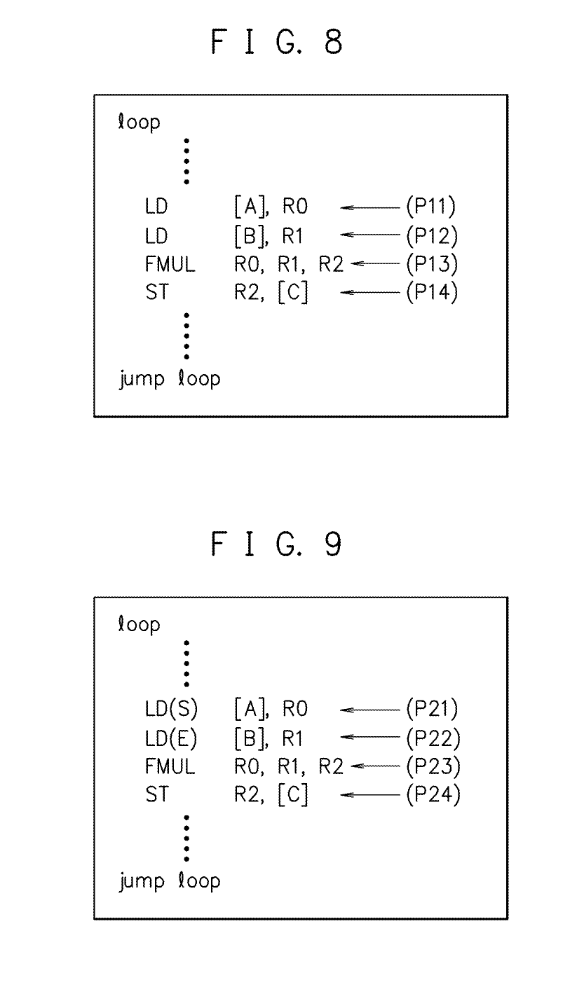

An exemplary implementation of the load request LD(S) and the load request LD(E) will be explained below. The description below deals with the case where the load request LD(S) and the load request LD(E) in this embodiment are applied to a program product illustrated in FIG. 8. The process illustrated in FIG. 8 is a loop in which the processes below are repeated, wherein in response to command P11, a data block with address A is stored in a register R0, and in response to command P12, a data block with address B is stored in a register R1. In response to command P13, the values stored in the register R0 and the register R1 are multiplied, the results is stored in a register R2, and in response to command P14, the value stored in the register R2 is written in a data block with address C. The address A is commonly referred multiple times by the individual cores (threads), whereas the addresses B and C are on the same cache line and are dedicated to the individual core (threads). The individual addresses A, B and C are to be updated every time the loop process is repeated, and data with the individual addresses A, B and C are to be contained not in the L1 cache memory 12, but are contained in the E state in the L2 cache memory 13.

FIG. 9 illustrates an exemplary case where the load request LD(S) and the load request LD(E) are newly defined and implemented. The load request directed to address A which is commonly referred multiple times by the individual cores (threads) in response to command P21, is used in the form of LD(S), whereas the load request directed to address B in response to command P22, characterized by storing after loading, is used in the form of LD(E). Note that command P23 and command P24 correspond respectively to the command P13 and the command P14 described in above. In this way, the load request directed to address A, which is referred multiple times, will have a response in the S state, successfully suppressing occurrence of processes regarding the snoop transaction and transfer of exclusive right of cache state and so forth, and improving the process performance of the processor.

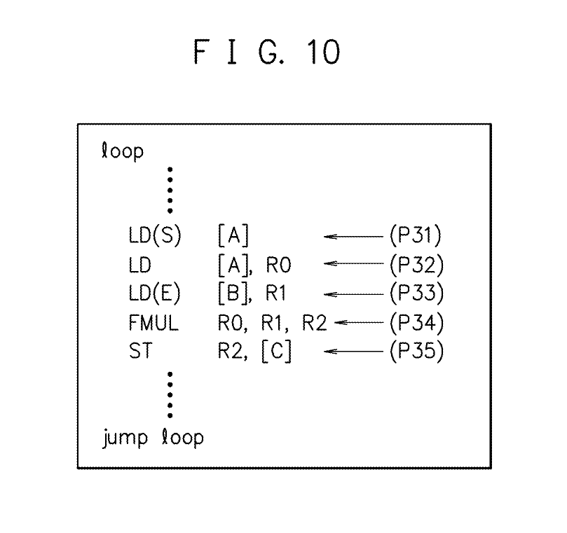

FIG. 10 illustrates another example in which the load request LD(S) and the load request LD(E) are newly defined and implemented. The example illustrated in FIG. 10 is configured to allow issuance of the request, without specifying a destination register. The LD(S) having no destination register specified thereto is used for the load request directed to address A which is commonly referred multiple times by the individual cores (threads) in response to command P31. When the command P31 is executed, the data block with the address A is held in the S state in the L1 cache memory 12. Next, in response to command P32, the load request is directed to address A, where the state of the L1 cache memory remains in the S state without being updated, since the cache hit is achieved in the L1 cache memory 12. Thereafter, LD(E) is used in the succeeding load request directed to address B in response to command P33, characterized by storing after loading. Note that command P34 and command P35 respectively correspond to the command P13 and the command P14 described above. Accordingly, the load request directed to address A, which is referred multiple times, will have a response in the S state, successfully suppressing occurrence of processes regarding the snoop transaction and transfer of exclusive right of cache state and so forth, and improving the process performance of the processor.

While the description above dealt with the case where the load request LD(S) and the load request LD(E) are newly provided, only the load request LD(S) may be newly provided in an alternative configuration in which a response is made in the E state upon issuance of the load request LD which does not specify the response.

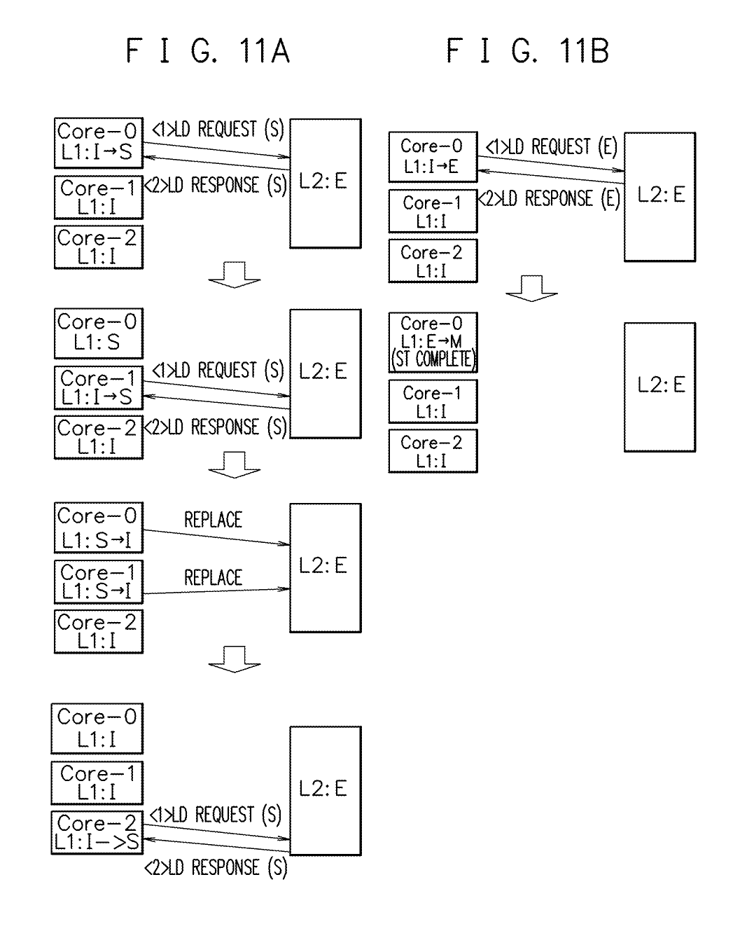

As described above, the load request less likely to be stored is handled in the form of LD(S), and the response is made in the S state. In this way, the response is made in the S state even after the replacement as illustrated in FIG. 11A, so that if the next core issues the load request, or the load request LD(S) on the same cache line, the snoop transaction will not occur between the first core and the next core, allowing immediate sharing of the data. In addition, the load request other than those less likely to be stored is handled in the form of LD(E), and the response is made in the E state. Accordingly, when the core issues the store request for the next time on the same cache line as illustrated in FIG. 11B, the core can immediately execute the store operation since it holds the data in the E state, so that the performance may be prevented from degrading.

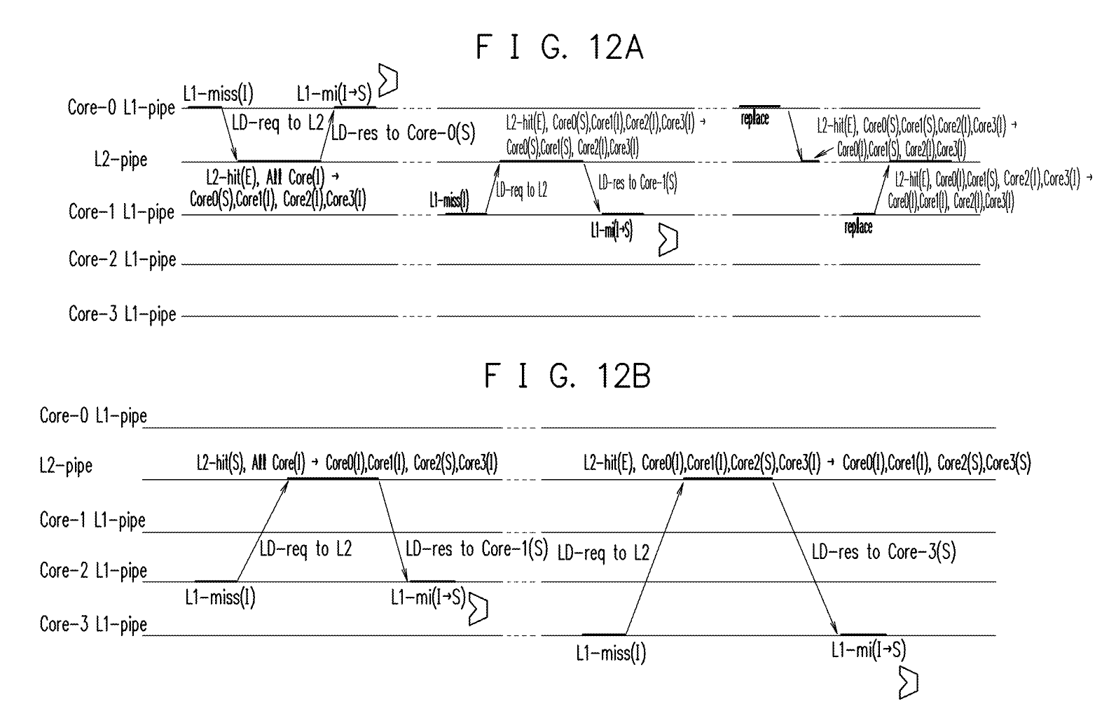

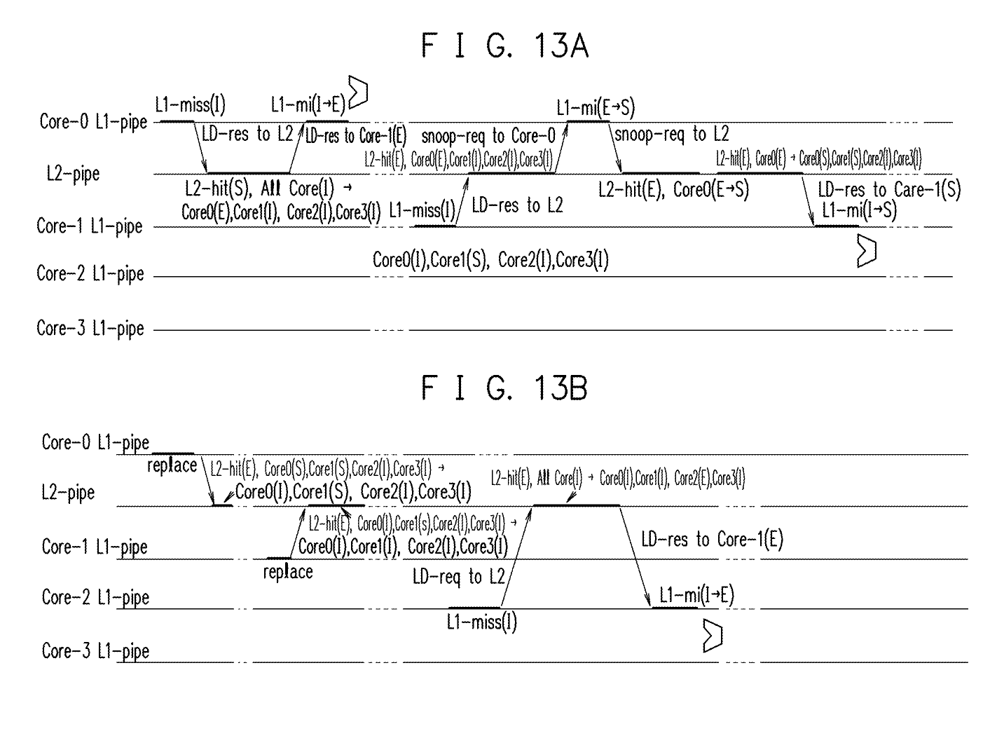

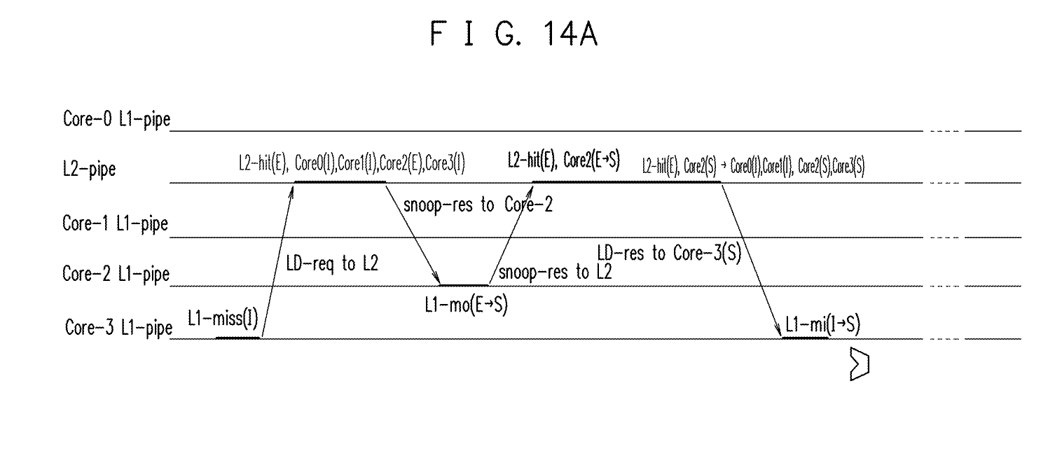

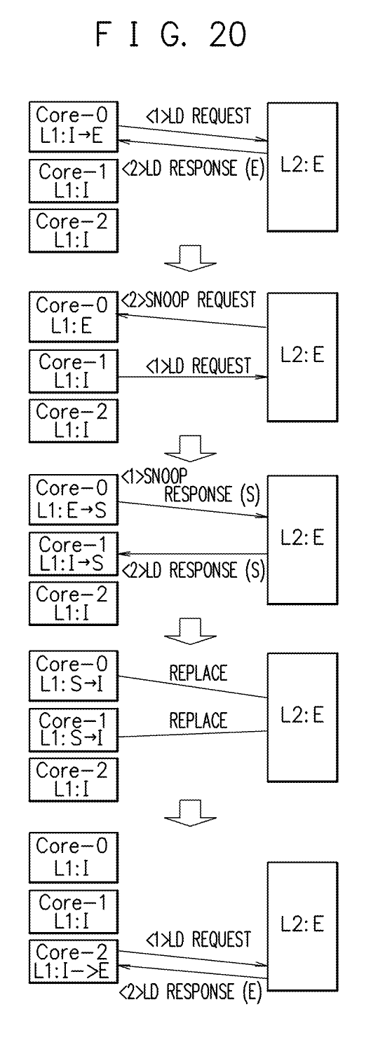

FIGS. 12A and 12B are drawings illustrating operational flows of the example illustrated in FIG. 11A, and FIGS. 13A, 13B and FIG. 14 are drawings illustrating operational flows of the example illustrated in FIG. 20. Note that, in FIGS. 12A to FIG. 14, Core-0 L1-pipe represents a pipeline processing by the L1 cache memory of the core 0, and Core-1 L1-pipe represents a pipeline processing by the L1 cache memory of the core 1. L1-pipe represents a pipeline processing by the L2 cache memory. As is clear from comparison between the operational flows illustrated in FIGS. 12A, 12B and the operational flows illustrated in FIGS. 13A, 13B and FIG. 14, processes regarding the snoop transaction and transfer of exclusive right of cache state and so forth are reduced in this embodiment, and thereby the process performance is improved.

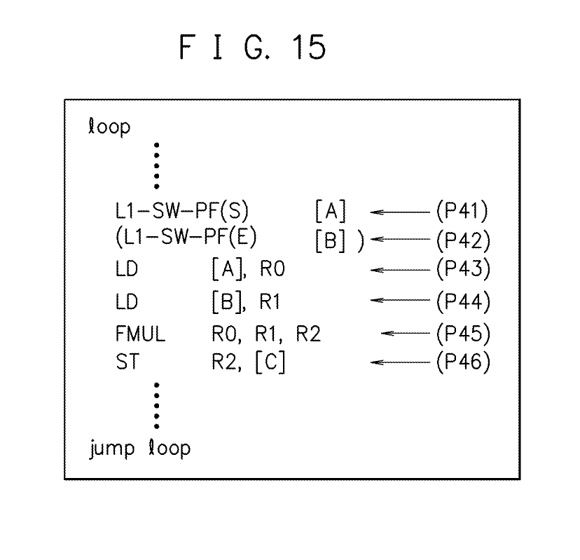

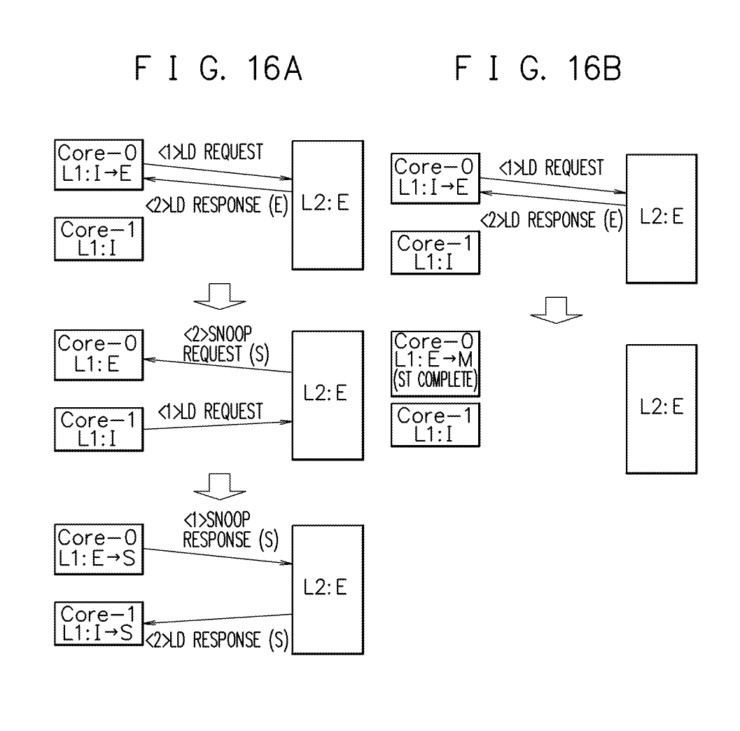

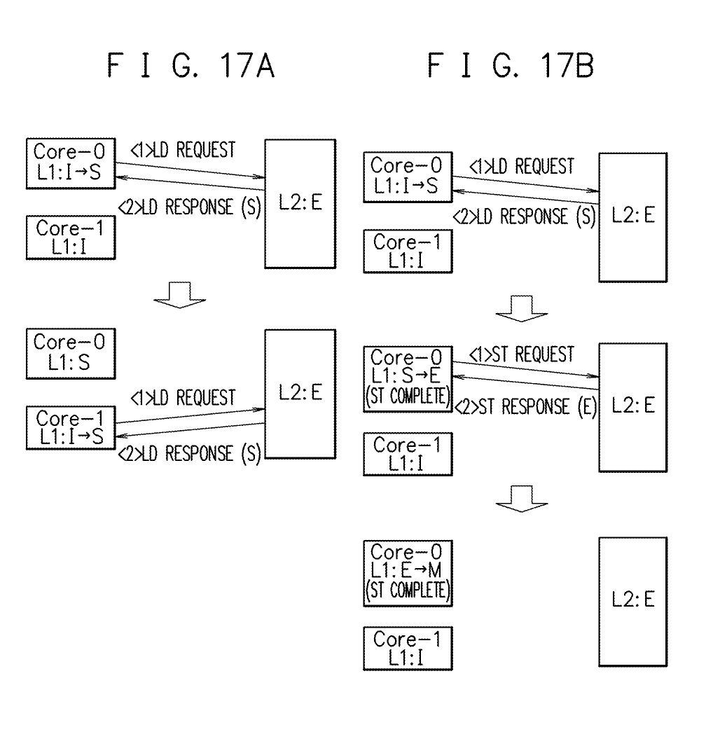

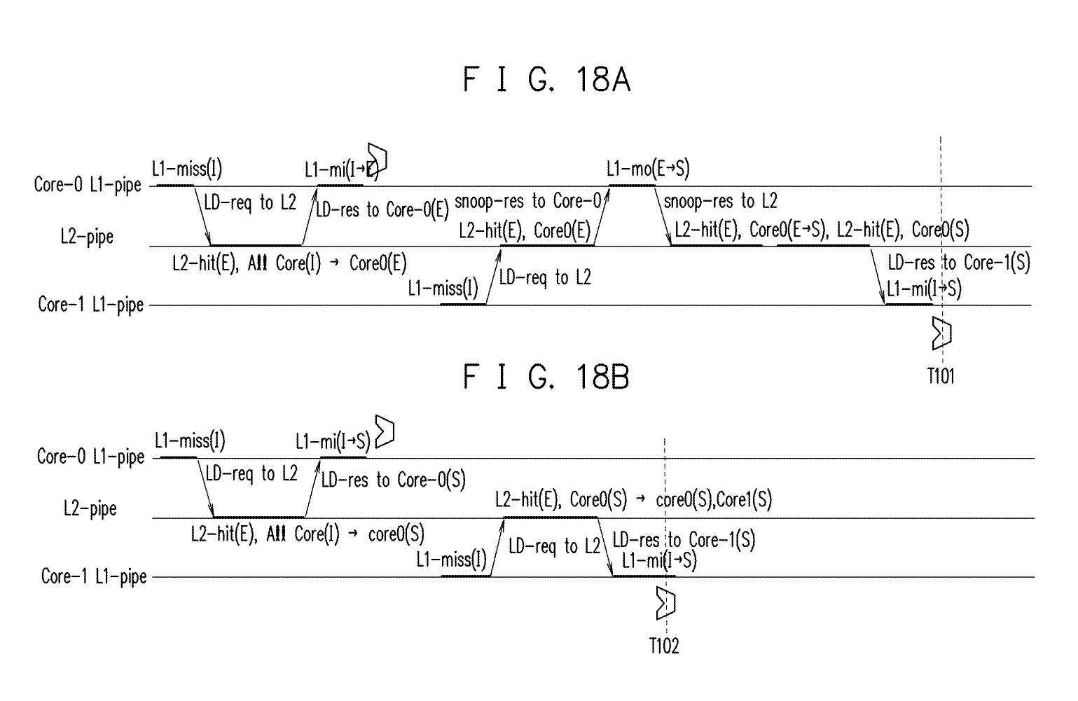

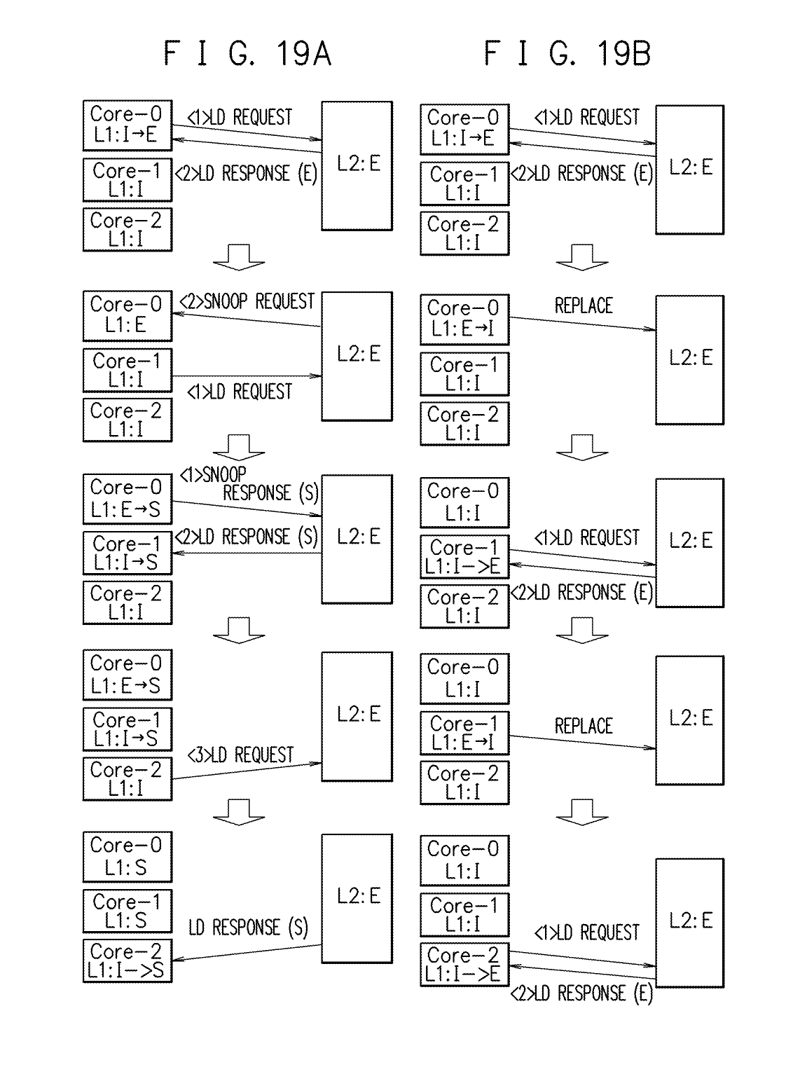

FIG. 15 is a drawing illustrating another exemplary implementation of the load request LD(S) and the load request LD(E) in this embodiment. The command P31 in the exemplary implementation illustrated in FIG. 10 is used for storing the data block with address A into the L1 cache memory 12, which is similar to so-called L1 cache prefetch. Accordingly, when the L1 cache prefetch (L1-PF) is defined by a command set, the load request LD(S) may be expressed by the L1-PF. The L1-PF is often used for improving the performance, by storing the data in the L2 cache memory into the L1 cache memory, before loading or storing.

The L1-PF includes L1-PF(S) which requests the prefetch only for the purpose of making reference, and L1-PF(E) which requests the prefetch for storing. Accordingly, the L1-PF(S) may be used as the load request LD(S) in this embodiment, so that it is no more necessary to newly define the load request LD(S), and this embodiment may be implemented without adding or modifying a command code. When the L1-PF(S) is used as the load request LD(S), it suffices that the request code decoding section 132 of the response decision section 19 interprets the L1-PF(S) as the load request LD(S).

In the example illustrated in FIG. 15, in response to command P41, the data block with address A, which is commonly referred multiple times by the individual cores (threads), is prefetched into the L1 cache memory 12. In this process, the L1 cache memory 12 holds the data block with address A in the S state. Next, in response to command P42, the data block with address B is prefetched into the L1 cache memory 12. In this process, the L1 cache memory 12 holds the data block with address B in the E state. The command P42 is omissible. Next, in response to command P43, the load request is directed to address A, where the state of the L1 cache memory remains in the S state without being updated, since the cache hit is achieved in the L1 cache memory 12. Thereafter, in response to command P44, the load request is directed to address B, where loading is followed by storing. Command P45 and command P46 respectively correspond to the command P13 and command P14 described above. Also in this configuration, a response to the load request directed to address A, which is repetitively referred multiple times, is made in the S state, so that processes regarding the snoop transaction and transfer of exclusive right of cache state and so forth are suppressed from occurring, and thereby the process performance of the processor may be improved.

The prefetch request is used to hide the latency of the L2 cache memory. Taking the latency of the L2 cache memory into account, several commands' worth (20 commands' worth, for example) of intervals may be provided between the command P41 (or command P42, if this is added) and the command P43.

There are two possible methods of expressing the load request LD(S) and the load request LD(E) using the L1-PF, which are a method of implementing the load request LD(E) only with the load request other than the L1-PF, and a method of implementing it together with the L1-PF(E). It is, however, better to implement the load request LD(E) only with the load request other than L1-PF, since the L1-PF(E) preferably holds the data in the E state for future storage. While the L1-PF is preferably assumed to be L1-SW(software)-PF designated by software, it is also adaptable to L1-HW(hardware)-PF by which the L1-PF is automatically generated by detecting a pattern of memory access address.

According to this embodiment, processes regarding the snoop transaction and transfer of exclusive right of cache state and so forth may be suppressed from occurring, and thereby the process performance of the processor may be improved, by making a response to the requestor after properly selecting which of the E state and the S state is to be used to make a response to the load request directed to a low-order cache memory. This embodiment described above is applicable not only to the cache system based on the MESI protocol, but also to any cache systems capable of transferring the exclusive right in a clean state. For example, this embodiment is also applicable to cache systems based on the MOESI protocol, MOWESI protocol and so forth.

According to one embodiment, upon issuance of the load request directed to a low-order cache memory, it is now possible to make a response in a proper state to the requestor, and thereby processes may successfully be reduced, and the process performance of the processor may be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
a plurality of processing sections, each including a first cache memory, that executes processing and issues a request; and
a second cache memory that,
when a request that requests a target data held by none of the first cache memories contained in the plurality of processing sections, and is received from any one of the plurality of processing sections, is a load request that permits a processing section other than the processing section having sent the request to hold the target data,
makes a response to the processing section having sent the request, with non-exclusive information that indicates that the target data is non-exclusive data, together with the target data; and
when the request is a load request that forbids a processing section other than the processing section having sent the request to hold the target data,
makes a response to the processing section having sent the request, with exclusive information which indicates that the target data is exclusive, together with the target data.

2. The processor according to claim 1,
wherein the second cache memory
has a storage unit that stores first hold status information indicating a hold status of the target data in the first cache memory, and second hold status information indicating a hold status of the target data in the second cache memory, as correlated with the target data, and
makes a response, based on the first hold status information and the second hold status information held in the storage unit, to the processing section having sent the request, with non-exclusive information or exclusive information corresponded to the target data.

3. The processor according to claim 2,
wherein the second cache memory further comprises:
a first decoding section that decodes a load request requesting a target data hit in the second cache memory;
a second decoding section that decodes the first hold status information and the second hold status information corresponded to a target data hit in the second cache memory; and
a response creating section that makes a response to the processing section having sent the request, based on a first result of decoding by the first decoding section and a second result of decoding by the second decoding section.

4. The processor according to claim 1,
wherein the request that requests the target data,
when it is a load request that also permits a processing section other than the processing section having sent the request to hold the target data,
is a prefetch request that preliminarily makes a response from the second cache memory to the first cache memory contained in the processing section having sent the request, with the target data, and the non-exclusive information corresponded to the target data.

5. The processor according to claim 1,
wherein the request that requests the target data,
when it is a load request that forbids a processing section other than the processing section having sent the request to hold the target data,
is a prefetch request that preliminarily makes a response from the second cache memory to the first cache memory contained in the processing section having sent the request, with the target data, and the exclusive information corresponded to the target data.

6. A control method of a processor that comprises a plurality of processing sections, each having a first cache memory, which executes processing, and a second cache memory connected to the plurality of processing sections,
the method allows any one of the plurality of processing sections to issue a request, and
allows the second cache memory,
when a request that requests a target data held by none of the first cache memories contained in the plurality of processing sections, and is received from any one of the plurality of processing sections, is a load request that permits a processing section other than the processing section having sent the request to hold the target data,
to make a response to the processing section having sent the request, with non-exclusive information that indicates that the target data is non-exclusive data, together with the target data; and
when the request is a load request that forbids a processing section other than the processing section having sent the request to hold the target data,
to make a response to the processing section having sent the request, with exclusive information that indicates that the target data is exclusive, together with the target data.
